(19) United States
(12) Patent Application Publication
(10) Pub. No.: US 2026/0113280 A1
(43) Pub. Date: Apr. 23, 2026

(54) SWITCH CONTROL METHOD AND APPARATUS, NON-VOLATILE READABLE STORAGE MEDIUM, AND ELECTRONIC APPARATUS

(71) Applicant: Suzhou MetaBrain Intelligent Technology Co., Ltd., Suzhou, Jiangsu (CN)

(72) Inventors: Yencheng LU, Suzhou, Jiangsu (CN); Bohsiung CHI, Suzhou, Jiangsu (CN); Chinjen HSU, Suzhou, Jiangsu (CN)

(21) Appl. No.: 19/152,904

(22) PCT Filed: Dec. 14, 2023
(86) PCT No.: PCT/CN2023/138959

§ 371 Date: Jul. 31, 2025

(30) Foreign Application Priority Data
Mar. 3, 2023 (CN) 202310199163.6

(51) Int. Cl. H04L 47/30; H04L 49/111

(52) U.S. Cl. CPC H04L 47/30; H04L 49/111

(57) ABSTRACT

Embodiments of the present application provide a switch control method and apparatus, a non-volatile readable storage medium, and an electronic apparatus. The switch control method includes: obtaining a first transmission quantity that is recorded in a priority flow control (PFC) counter in a reference switch and that corresponds to a target message queue; and in a case that the first transmission quantity satisfies a preset first control condition, transmitting a first control instruction to a target switch, where the first control instruction is configured for instructing a discarding operation on a message in the target message queue.

### CROSS-REFERENCE TO RELATED APPLICATION

This application claims priority to Chinese Patent Application No. 202310199163.6, entitled “SWITCH CONTROL METHOD AND APPARATUS, STORAGE MEDIUM, AND ELECTRONIC APPARATUS” filed with the China National Intellectual Property Administration on Mar. 3, 2023, which is incorporated herein by reference in its entirety.

### FIELD

Embodiments of the present application relate to the field of switches, and in particular, to a switch control method and apparatus, a non-volatile readable storage medium, and an electronic apparatus.

### BACKGROUND

In a process of transmitting messages via a switch, a priority flow control (PFC) counter in the switch often needs to be read regularly to detect whether a PFC storm has occurred. In case of detecting the PFC storm, a PFC pause is transmitted. However, not all switch chips are equipped with PFC counters. For example, considering costs, some chips may share one PFC counter, or some switches may be deployed with PFC counters, but the PFC counters on the switches may not be used due to damage or other reasons. In this way, switches without PFC functions may not detect and mitigate the PFC storm generated by each port.

In the related art, an effective solution has not yet been proposed to address a technical issue of switches without PFC counters being unable to detect the PFC storm in a case that the PFC storm occurs.

### SUMMARY

The embodiments of the present application provide a switch control method and apparatus, a non-volatile readable storage medium, and an electronic apparatus, to at least solve the problem that a switch that is not deployed with a PFC counter may not detect a PFC storm in the related art.

According to some embodiments of the present application, a switch control method is provided, including: obtaining a first transmission quantity that is recorded in a priority flow control (PFC) counter in a reference switch and that corresponds to a target message queue, where the first transmission quantity is a quantity of PFC pause frames that are transmitted by the reference switch to a target switch and that correspond to the target message queue, and the target message queue is a message queue on the target switch; and in a case that the first transmission quantity satisfies a preset first control condition, transmitting a first control instruction to the target switch, where the first control instruction is configured for instructing a discarding operation on a message in the target message queue.

In some exemplary embodiments, before the transmitting a first control instruction to the target switch, the method further includes: in a case that the first transmission quantity is greater than or equal to a preset first quantity threshold, determining that the first transmission quantity satisfies the first control condition; or in a case of determining, based on the first transmission quantity, that a quantity of PFC pause frames that are transmitted by the reference switch to the target switch within first preset duration and that correspond to the target message queue is greater than or equal to a preset second quantity threshold, determining that the first transmission quantity satisfies the first control condition.

In some exemplary embodiments, the method further includes: obtaining a previous transmission quantity, where the previous transmission quantity is a cumulative quantity of PFC pause frames that are transmitted by the reference switch to the target switch at a first moment and that correspond to the target message queue; the first transmission quantity is a cumulative quantity of PFC pause frames that are transmitted by the reference switch to the target switch at a second moment and that correspond to the target message queue; the first moment is earlier than the second moment; duration between the first moment and the second moment is the first preset duration; and determining a quantity difference between the first transmission quantity and the previous transmission quantity as the quantity of PFC pause frames that are transmitted by the reference switch to the target switch within the first preset duration and that correspond to the target message queue.

In some exemplary embodiments, the transmitting a first control instruction to the target switch includes: transmitting the first control instruction to a second transmission module in the target switch through a first transmission module in the reference switch, where the first transmission module and the second transmission module are connected through a first port of the reference switch and a second port of the target switch; the target message queue is a message queue at the second port of the target switch; the first control instruction includes a queue number of the target message queue and a first operation identification; and the first operation identification is configured for performing the discarding operation on the message.

In some exemplary embodiments, the transmitting the first control instruction to a second transmission module in the target switch through a first transmission module in the reference switch includes: transmitting the first control instruction to a second link layer discovery protocol (LLDP) module in the target switch via a target transmission link through a first LLDP module in the reference switch, where the first control instruction is a message that is encapsulated in a transmission format of LLDP; and the target transmission link is a transmission link between the first port and the second port.

In some exemplary embodiments, the transmitting a first control instruction to the target switch includes: transmitting the first control instruction to a fourth transmission module in the target switch by a network controller through a third transmission module in the reference switch, where the first control instruction includes an Internet protocol (IP) address of the reference switch, an IP address of the target switch, a first port number of a first port of the reference switch, a second port number of a second port of the target switch, a queue number of the target message queue, and a first operation identification; and the first operation identification is configured for performing the discarding operation on the message.

In some exemplary embodiments, after the transmitting a first control instruction to the target switch, the method includes: obtaining a second transmission quantity that is recorded in the PFC counter in the reference switch and that corresponds to the target message queue; and in a case that the second transmission quantity satisfies a preset second control condition, transmitting a second control instruction to the target switch, where the second control instruction is used to instruct to perform a retaining operation on a message in the target message queue.

In some exemplary embodiments, before the transmitting a second control instruction to the target switch, the method further includes: in a case that the second transmission quantity is less than a preset third quantity threshold, determining that the second transmission quantity satisfies the second control condition; or in a case of determining, based on the second transmission quantity, that a quantity of PFC pause frames that are transmitted by the reference switch to the target switch within second preset duration and that correspond to the target message queue is less than a preset fourth quantity threshold, determining that the second transmission quantity satisfies the second control condition.

In some exemplary embodiments, the transmitting a second control instruction to the target switch includes: transmitting the second control instruction to the second transmission module in the target switch through the first transmission module in the reference switch, where the first transmission module and the second transmission module are connected through the first port of the reference switch and the second port of the target switch; the target message queue is the message queue at the second port on the target switch; the second control instruction includes the queue number of the target message queue and the second operation identification; and the second operation identification is configured for performing the retaining operation on the message.

In some exemplary embodiments, the transmitting a second control instruction to the target switch includes: transmitting the second control instruction to the second LLDP module in the target switch via the target transmission link through the first LLDP module in the reference switch, where the second control instruction is a message that is encapsulated in the transmission format of LLDP; and the target transmission link is the transmission link between the first port and the second port.

In some exemplary embodiments, the transmitting a second control instruction to the target switch includes: transmitting the second control instruction to the fourth transmission module in the target switch by the network controller through the third transmission module in the reference switch, where the second control instruction includes the IP address of the reference switch, the IP address of the target switch, the first port number of the first port of the reference switch, the second port number of the second port of the target switch, the queue number of the target message queue, and the second operation identification; and the second operation identification is configured for performing the retaining operation on the message.

In some exemplary embodiments, after the transmitting a second control instruction to the target switch, the method further includes: obtaining the queue number of the target message queue and the second operation identification from the second control instruction, where the second control instruction is a control instruction received from the second port; and performing the retaining operation on the message in the target message queue at the second port of the target switch, where the target message queue is a message queue identified by the queue number; and the retaining operation is an operation indicated by the second operation identification.

In some exemplary embodiments, the performing the retaining operation on the message in the target message queue at the second port of the target switch includes: deleting an access control list (ACL) rule generated by an ACL control module, where the ACL rule is configured for instructing the discarding operation on the message in the target message queue.

In some exemplary embodiments, after the transmitting a second control instruction to the target switch, the method further includes: obtaining the second port number, the queue number of the target message queue, and the second operation identification from the second control instruction; and performing the retaining operation on the message in the target message queue at the second port of the target switch, where the second port is a port identified by the second port number; the target message queue is a message queue identified by the queue number; and the retaining operation is an operation indicated by the second operation identification.

According to other embodiments of the present application, a switch control method is further provided, including: obtaining a first control instruction transmitted by a reference switch, where the first control instruction is configured for instructing a discarding operation on a message in a target message queue; the first control instruction is a control instruction that is transmitted from the reference switch to a target switch in a case that a first transmission quantity satisfies a preset first control condition; the target message queue is a message queue on the target switch; the first transmission quantity is recorded in a priority flow control (PFC) counter in the reference switch, and the first transmission quantity is a quantity of PFC pause frames that are transmitted by the reference switch to the target switch and that correspond to the target message queue; and in response to the first control instruction, performing the discarding operation on the message in the target message queue on the target switch.

In some exemplary embodiments, the obtaining a first control instruction transmitted by a reference switch includes: obtaining the first control instruction transmitted by a first port of the reference switch to a second port of the target switch, where the first control instruction includes a queue number and the target message queue and a first operation identification; the first operation identification is configured for performing the discarding operation on the message; the target message queue is a message queue at the second port of the target switch; the performing the discarding operation on the message in the target message queue on the target switch includes: obtaining the queue number of the target message queue and the first operation identification from the first control instruction; and performing the discarding operation on the message in the target message queue at the second port of the target switch, where the target message queue is a message queue identified by the queue number; and the discarding operation is an operation indicated by the first operation identification.

In some exemplary embodiments, the performing the discarding operation on the message in the target message queue on the target switch includes: generating an access control list (ACL) rule through an ACL control module in the target switch, where the ACL rule is configured for instructing the discarding operation on the message in the target message queue; and performing the discarding operation on the message in the target message queue based on the ACL rule.

In some exemplary embodiments, the obtaining a first control instruction transmitted by the reference switch includes: obtaining the first control instruction transmitted to a fourth transmission module in the target switch by a network controller through a third transmission module in the reference switch, where the first control instruction includes an IP address of the reference switch, an IP address of the target switch, a first port number of a first port of the reference switch, a second port number of a second port of the target switch, and a queue number of the target message queue, and a first operation identification; the first operation identification is configured for performing the discarding operation on the message; the target message queue is a message queue at the second port of the target switch; the performing the discarding operation on the message in the target message queue on the target switch includes: obtaining the second port number, the queue number of the target message queue, and the first operation identification from the first control instruction; and performing the discarding operation on the message in the target message queue at the second port of the target switch, where the second port is a port identified by the second port number; and the target message queue is a message queue identified by the queue number; and the discarding operation is an operation indicated by the first operation identification.

In some exemplary embodiments, the performing the discarding operation on the message in the target message queue at the second port of the target switch includes: generating an ACL rule through an ACL control module in the target switch, where the ACL rule is configured for instructing the discarding operation on the message in the target message queue at the second port; and performing the discarding operation on the message in the target message queue at the second port based on the ACL rule.

According to other embodiments of the present application, a switch control apparatus is provided, including: a first obtaining module, configured for obtaining a first transmission quantity that is recorded in a priority flow control (PFC) counter in a reference switch and that corresponds to a target message queue, where the first transmission quantity is a quantity of PFC pause frames that are transmitted by the reference switch to a target switch and that correspond to the target message queue, and the target message queue is a message queue on the target switch; and a first transmission module, configured for: in a case that the first transmission quantity satisfies a preset first control condition, transmitting a first control instruction to the target switch, where the first control instruction is configured for instructing a discarding operation on a message in the target message queue.

According to other embodiments of the present application, a switch control apparatus is provided, including: a sixth obtaining module, configured for obtaining a first control instruction transmitted by a reference switch, where the first control instruction is configured for instructing a discarding operation on a message in a target message queue; the first control instruction is a control instruction that is transmitted from the reference switch to a target switch in a case that a first transmission quantity satisfies a preset first control condition; the target message queue is a message queue on the target switch; the first transmission quantity is recorded in a priority flow control (PFC) counter in the reference switch, and the first transmission quantity is a quantity of PFC pause frames that are transmitted by the reference switch to the target switch and that correspond to the target message queue; and a third execution module, configured for: in response to the first control instruction, performing the discarding operation on the message in the target message queue on the target switch.

According to still other embodiments of the present application, a non-volatile readable storage medium is further provided. The non-volatile readable storage medium has a computer program stored thereon, and the computer program is configured for, when executed, performing the steps in any one of the above method embodiments.

According to yet other embodiments of the present application, an electronic apparatus is further provided, including a memory and a processor. The memory has a computer program stored thereon. The processor is configured for executing the computer program to perform the steps in any one of the above method embodiments.

By the embodiments of the present application, in the process of transmitting a message by the target switch to the reference switch, the PFC counter in the reference switch records the quantity of PFC pause frames that are transmitted by the reference switch to the target switch and that correspond to the target message queue. In a case that the quantity of pause frames satisfies a control condition, it may indicate that a PFC storm occurs in the target message queue on the target switch. In this case, a control instruction is transmitted to a switch without a PFC counter function, to cause the switch without the PFC counter function to discard a message in a congested message queue in a timely manner, thereby avoiding aggravation of the congestion of the message queue, in which the PFC storm occurs, on the target switch. Therefore, the problem that the switch without the PFC counter may not detect a PFC storm may be solved, whereby the switch without the PFC counter may detect a PFC storm in a timely manner in a case that the PFC storm occurs.

### BRIEF DESCRIPTION OF THE DRAWINGS

FIG. 1 is a structural block diagram of hardware of a mobile terminal in a switch control method according to some embodiments of the present application;

FIG. 2 is a schematic diagram of an application scenario of a switch control method according to some embodiments of the present application;

FIG. 3 is a schematic diagram of transmission and receiving of pause frames according to some embodiments of the present application;

FIG. 4 is a schematic diagram of a switch control method according to some embodiments of the present application;

FIG. 5 is a flowchart I of a switch control method according to some embodiments of the present application;

FIG. 6 is a schematic diagram of determining a quantity of PFC pause frames that are transmitted by a reference switch to a target switch within first preset duration and that correspond to a target message queue according to some embodiments of the present application;

FIG. 7 is a schematic diagram of a first control instruction according to some embodiments of the present application;

FIG. 8 is a flowchart II of a switch control method according to some embodiments of the present application;

FIG. 9 is a schematic diagram I of performing a discarding operation on a message in a target message queue according to some embodiments of the present application;

FIG. 10 is a schematic diagram II of performing a discarding operation on a message in a target message queue according to some embodiments of the present application;

FIG. 11 is a structural block diagram I of a switch control apparatus according to some embodiments of the present application; and

FIG. 12 is a structural block diagram II of a switch control apparatus according to some embodiments of the present application.

### DETAILED DESCRIPTION

The embodiments of the present application will be described in detail below with reference to the accompanying drawings and the embodiments.

It should be noted that the terms “first”, “second”, etc. in the specification and claims of the embodiments of the present application and the above accompanying drawings are defined to distinguish similar objects, and do not have to be used to describe a specific order or sequence.

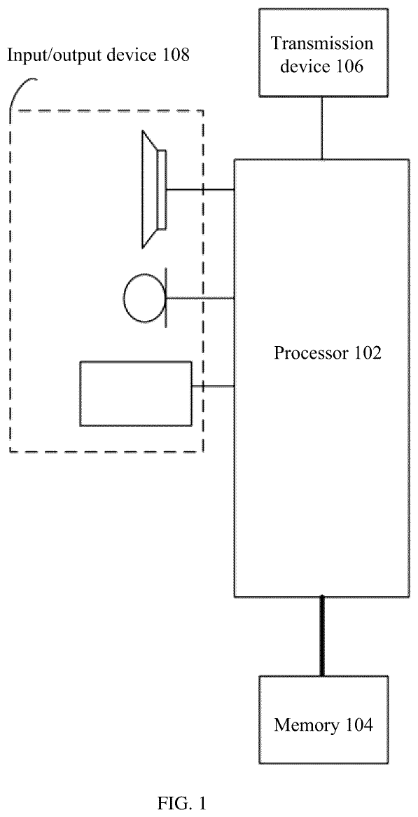

Method embodiments provided in the embodiments of the present application may be performed on a mobile terminal, a computer terminal, or a similar computing device. An example in which the method is performed on the mobile terminal is used. FIG. 1 is a structural block diagram of hardware of a mobile terminal in a switch control method according to some embodiments of the present application. As shown in FIG. 1, the mobile terminal may include one or more processors 102 (one processor is shown in FIG. 1) (the processor 102 may include, but is not limited to, a micro processing unit (MCU), a field programmable gate array (FPGA), and other processing apparatuses) and a memory 104 configured for storing data. The above mobile terminal may also include a transmission device 106 with a communication function and an input/output device 108 with a communication function. A person of ordinary skill in the art may understood that the structures shown in FIG. 1 are illustrative, and a limitation will not be made on the structures of the mobile terminal. For example, the mobile terminal may further include more or fewer components than those shown in FIG. 1, or have configurations different from those shown in FIG. 1.

The memory 104 is configured for storing a computer program, for example, a software program and a module of application software, such as a computer program corresponding to a switch control method in the embodiments of the present application. The processor 102 executes various functional applications and data processing by executing the computer program stored in the memory 104, namely, implements the above method. The memory 104 may include high-speed random-access memory and may also include a non-volatile memory, such as one or more magnetic storage apparatuses, a flash memory, or other non-volatile solid state memories. In some examples, the memory 104 may include a memory remotely located with respect to the processor 102. These remote memories may be connected to the mobile terminal through a network. Examples of the above network include, but are not limited to, Internets, intranets, local area networks, mobile communication networks, and combinations thereof.

The transmission device 106 is configured for receiving or transmitting data through a network. The examples of the above network may include a wireless network provided by a communication provider of the mobile terminal. In some examples, the transmission device 106 includes a network interface controller (NIC) that may be connected to other network devices through a base station for communication with the Internet. In some examples, the transmission device 106 may be a radio frequency (RF) module configured for communicating with the Internet in a radio manner.

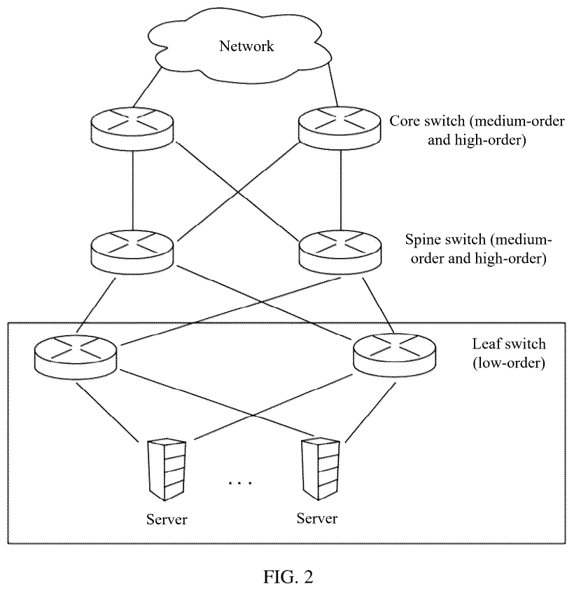

FIG. 2 is a schematic diagram of an application scenario of a switch control method according to some embodiments of the present application. As shown in FIG. 2, a data center typically employs a Core/Spine/Leaf three-layer architecture. A Leaf switch (i.e. a target switch) employs a low-order chip without a PFC counter. A Spine-layer switch (i.e. a reference switch) includes a priority flow control (PFC) counter and may observe a quantity of PFC pause frames that are transmitted by the Spine-layer switch to the Leaf switch.

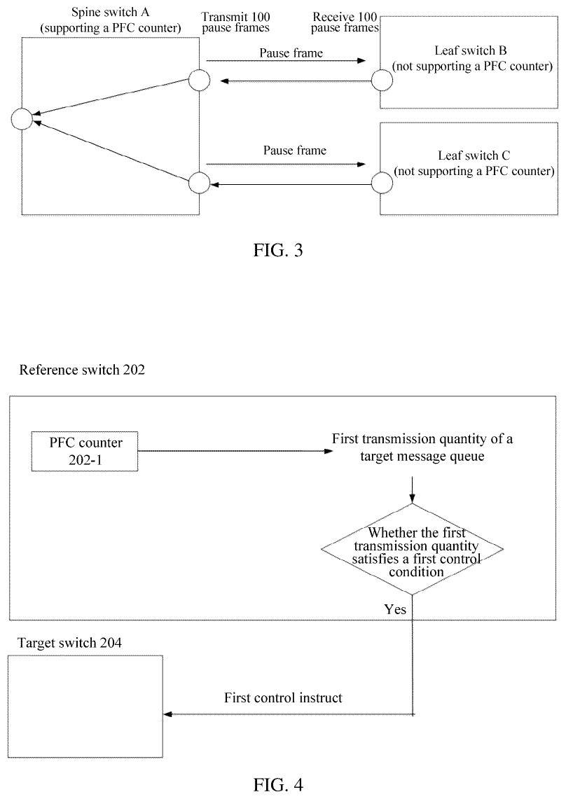

FIG. 3 is a schematic diagram of transmission and receiving of pause frames according to some embodiments of the present application. As shown in FIG. 3, a quantity of PFC pause frames that are transmitted by a Spine-layer switch A supporting a PFC counter to a Leaf switch B and a quantity of PFC pause frames received by the Leaf switch B are the same. A quantity of PFC pause frames that are transmitted by the Spine-layer switch A supporting the PFC counter to a Leaf switch C and a quantity of PFC pause frames received by the Leaf switch C are the same. For example: the Spine-layer switch A supporting the PFC counter transmits 100 PFC pause frames to the Leaf switch B, and the Leaf switch B receives 100 PFC pause frames.

With reference to FIG. 2 and FIG. 3, by the embodiments of the present application, whether a PFC storm occurs in the switch B may be determined based on the quantity, recorded by the PFC counter in the switch A, of the pause frames that are transmitted by the switch A to the switch B, that is, a priority flow control watchdog (PFCWD) behavior of the switch B may be controlled according to the switch A. Whether a PFC storm occurs in the switch C may be determined based on the quantity, recorded by the PFC counter in the switch A, of the pause frames that are transmitted by the switch A to the switch C, that is, a priority flow control watchdog (PFCWD) behavior of the switch C may be controlled according to the switch A.

FIG. 4 is a schematic diagram of a switch control method according to some embodiments of the present application. As shown in FIG. 4, a first transmission quantity that is recorded in a priority flow control (PFC) counter 202-1 in a reference switch 202 and that corresponds to a target message queue. In a case that the first transmission quantity satisfies a preset first control condition, a first control instruction is transmitted to a target switch 204, to cause the target switch 204 to discard a message in the target message queue. In this way, in a case that hardware of a switch (i.e. the target switch 204) without a PFC counter function is not upgraded, the switch without the PFC counter function may have a PFCWD function.

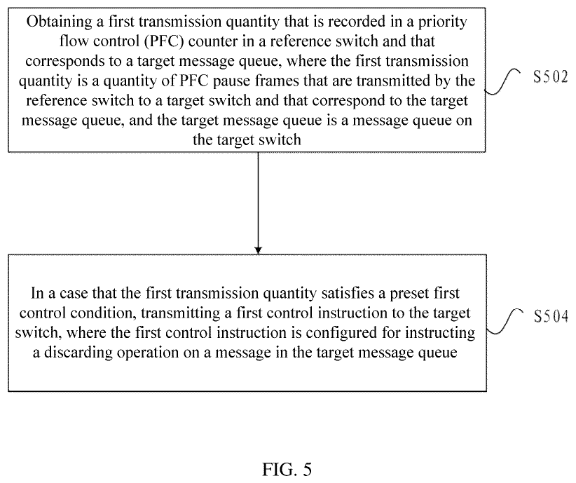

These embodiments provide a switch control method run on the above mobile terminal. FIG. 5 is a flowchart I of a switch control method according to some embodiments of the present application. As shown in FIG. 5, the flow includes following steps:
Step S502, obtaining a first transmission quantity that is recorded in a priority flow control (PFC) counter in a reference switch and that corresponds to a target message queue, where the first transmission quantity is a quantity of PFC pause frames that are transmitted by the reference switch to a target switch and that correspond to the target message queue, and the target message queue is a message queue on the target switch.
Step S504, in a case that the first transmission quantity satisfies a preset first control condition, transmitting a first control instruction to the target switch, where the first control instruction is configured for instructing a discarding operation on a message in the target message queue.

By the above steps, in the process of transmitting a message by the target switch to the reference switch, the PFC counter in the reference switch records the quantity of PFC pause frames that are transmitted by the reference switch to target message queue on the target switch. In a case that the quantity of pause frames satisfies a control condition, it may indicate that a PFC storm occurs in the target message queue on the target switch. In this case, a control instruction is transmitted to a switch without a PFC counter function, to cause the switch without the PFC counter function to discard a message in a congested message queue in a timely manner, thereby avoiding aggravation of the congestion of the message queue, in which the PFC storm occurs, on the target switch. Therefore, the problem that the switch without the PFC counter may not detect a PFC storm may be solved, whereby the switch without the PFC counter may detect a PFC storm in a timely manner in a case that the PFC storm occurs.

An execution entity of the above steps may be, but is not limited to, a terminal and the like.

Execution orders of step S502 and step S504 may be interchanged. That is, step S504 may be executed before step S502.

In the technical solution provided by step S502, the reference switch is deployed with the PFC counter, and the target switch may not be deployed with a PFC counter, but is not limited thereto, or if a PFC counter in the target switch fails and may not work, the target switch may not detect whether a PFC storm occurs in the target switch.

In these embodiments, the target switch includes a plurality of message queues. Each of the plurality of message queues may, but is not limited to, have a corresponding PFC counter in the reference switch.

In these embodiments, the target switch may, but is not limited to, transmit a message to the reference switch. In a case that a queue in the reference switch has an insufficient cache space, a pause frame with PFC information may be generated. In a case that the reference switch transmits the PFC pause frame to the target switch and the target switch receives the PFC pause frame, transmission of a message in the target message queue to the reference switch may be paused.

In the technical solution provided in step S504, in a case that the first transmission quantity meets the preset first control condition, it may indicate that a PFC storm has occurred in the target message queue on the target switch. In this case, since no PFC counter is deployed on the target switch, the reference switch needs to transmit the first control instruction to the target switch. The target switch timely performs the discarding operation on the message in the target message queue that has experienced the PFC storm, thereby avoiding collapse of an entire link.

In these embodiments, in a case that it is observed that the target switch receives PFC pause frames all the time within a time period of 400 ms (which may be, but is not limited to, 300 ms or 200 ms. The present application does not limit the time which is typically not shorter than 100 ms), it may indicate that a PFC occurs.

In some exemplary embodiments, determining that the first transmission quantity satisfies the first control condition may include, but is not limited to, one of the following scenarios:

Scenario I, in a case that the first transmission quantity is greater than or equal to a preset first quantity threshold, determining that the first transmission quantity satisfies the first control condition.

In these embodiments, in a case that, but is not limited to, the first transmission quantity reaches an absolute value, for example, the first transmission quantity reaches 200, 300, or 600, it may determine that the first transmission quantity satisfies the first control condition.

Scenario II, in a case of determining, based on the first transmission quantity, that a quantity of PFC pause frames that are transmitted by the reference switch to the target switch within first preset duration and that correspond to the target message queue is greater than or equal to a preset second quantity threshold, determining that the first transmission quantity satisfies the first control condition.

In these embodiments, in a case that the quantity of PFC pause frames that are transmitted by the reference switch to the target switch within the first preset duration and that correspond to the target message queue is greater than or equal to the preset second quantity threshold, it determines that the first transmission quantity satisfies the first control condition. For example: in a case that the quantity of PFC pause frames that are transmitted by the reference switch to the target switch within 400 ms and that correspond to the target message queue is greater than or equal to 400, it determines that the first transmission quantity satisfies the first control condition.

In some exemplary embodiments, the quantity of PFC pause frames that are transmitted by the reference switch to the target switch within the first preset duration and that correspond to the target message queue may be determined by, but not limited to, the following mode: obtaining a previous transmission quantity, where the previous transmission quantity is a cumulative quantity of PFC pause frames that are transmitted by the reference switch to the target switch at a first moment and that correspond to the target message queue; the first transmission quantity is a cumulative quantity of PFC pause frames that are transmitted by the reference switch to the target switch at a second moment and that correspond to the target message queue; the first moment is earlier than the second moment; duration between the first moment and the second moment is the first preset duration; and determining a quantity difference between the first transmission quantity and the previous transmission quantity as the quantity of PFC pause frames that are transmitted by the reference switch to the target switch within the first preset duration and that correspond to the target message queue.

In these embodiments, the quantity of PFC pause frames that are transmitted by the reference switch to the target switch within the first preset duration and that correspond to the target message queue may be determined based on, but not limited to, quantities, recorded in the PFC counter in the reference switch, of PFC pause frames transmitted by the reference switch to a plurality of queues in a plurality of ports of the target switch.

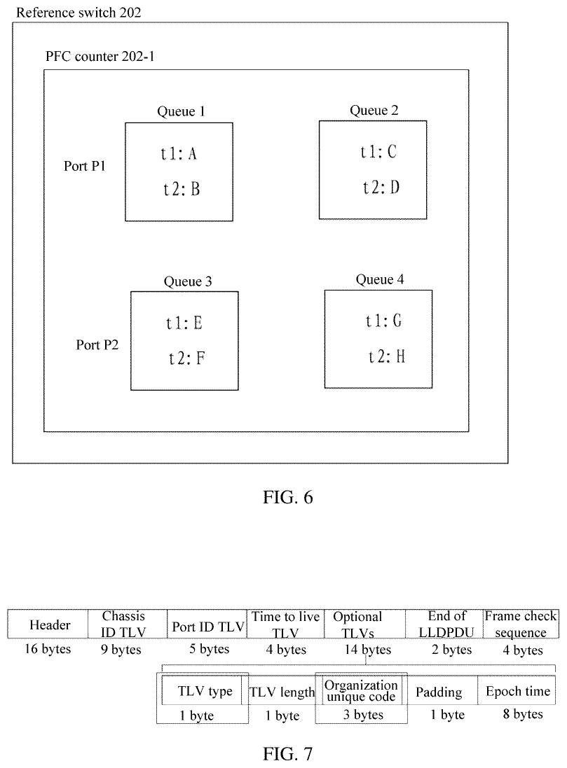

FIG. 6 is a schematic diagram of determining a quantity of PFC pause frames that are transmitted by a reference switch to a target switch within first preset duration and that correspond to a target message queue according to some embodiments of the present application. As shown in FIG. 6, a target switch 204 may include, but not limited to, port P1 and port P2. Port P1 includes queue 1 and queue 2, and port P2 includes queue 3 and queue 4.

A PFC counter 202-1 in a reference switch 202 records a cumulative quantity A of PFC pause frames that are transmitted by the reference switch 202 to queue 1 in port P1 of the target switch 204 at moment t1, a cumulative quantity C of PFC pause frames that are transmitted by the reference switch 202 to queue 2 in port P1 of the target switch 204 at moment t1, a cumulative quantity B of PFC pause frames that are transmitted by the reference switch 202 to queue 1 in port P1 of the target switch 204 at moment t2, and a cumulative quantity D of PFC pause frames that are transmitted by the reference switch 202 to queue 2 in port P1 of the target switch 204 at moment t2.

The PFC counter 202-1 in the reference switch 202 records a cumulative quantity E of PFC pause frames that are transmitted by the reference switch 202 to queue 3 in port P2 of the target switch 204 at moment t1, a cumulative quantity G of PFC pause frames that are transmitted by the reference switch 202 to queue 4 in port P2 of the target switch 204 at moment t1, a cumulative quantity F of PFC pause frames that are transmitted by the reference switch 202 to queue 3 in port P2 of the target switch 204 at moment t2, and a cumulative quantity H of PFC pause frames that are transmitted by the reference switch 202 to queue 4 in port P2 of the target switch 204 at moment t2.

Duration between moment t1 and moment t2 is the first preset duration. For queue 1 (i.e. the target message queue), a value difference between the cumulative quantity A (i.e. the first transmission quantity) of PFC pause frames at moment t1 (i.e. the first moment) and the cumulative quantity B (i.e. the previous transmission quantity) of PFC pause frames at moment t2 (i.e. the second moment) is determined as the quantity of PFC pause frames that are transmitted by the reference switch 202 to the target switch 204 within the duration between moment t1 and moment t2 and that correspond to queue 1.

It should be noted that the PFC counter 202-1 of the reference switch 202 may, but is not limited to, not store a quantity of PFC pause frames that are transmitted by the reference switch 202 to the target switch 204 at each moment, but store quantities of PFC pause frames that are transmitted by the reference switch 202 to the target switch 204 at a current moment and a previous moment of the current moment.

In some exemplary embodiments, a first control instruction may be transmitted to the target switch by, but not limited to, the following mode: transmitting the first control instruction to a second transmission module in the target switch through a first transmission module in the reference switch, where the first transmission module and the second transmission module are connected through a first port of the reference switch and a second port of the target switch; the target message queue is a message queue at the second port of the target switch; the first control instruction includes a queue number of the target message queue and a and first operation identification; and the first operation identification is configured for performing the discarding operation on the message.

In these embodiments, in a case that the first transmission module of the reference switch and the second transmission module of the target switch are connected through the first port of the reference switch and the second port of the target switch, it may indicate that the reference switch and the target switch are directly connected. In this case, the queue number of the target message queue on which the discarding operation is to be performed may be transmitted through the first transmission module.

In some exemplary embodiments, a first control instruction may be transmitted to the target switch by, but not limited to, the following mode: transmitting the first control instruction to a second link layer discovery protocol (LLDP) module in the target switch via a target transmission link through a first LLDP module in the reference switch, where the first control instruction is a message that is encapsulated in a transmission format of LLDP; and the target transmission link is a transmission link between the first port and the second port.

In these embodiments, the first control instruction may be, but is not limited to, the message encapsulated in the transmission format of LLDP. LLDP is a link layer discovery protocol that organizes information of a local device into TLV (type/length/value), which is encapsulated in a link layer discovery protocol data unit (LLDPDU) for being transmitted to a directly connected neighbor (i.e. a switch), and further saves an LLDPDU received from the neighbor in a form of a standard management information base (MIB). Based on the LLDP, a device may save and manage information of the device and information of the directly connected neighboring device, whereby a network management system may query and determine a communication condition of a link.

In these embodiments of the present application, in a case of a PFC storm, the reference switch transmits an LLDP packet configuration TLV Type=127 to the target switch, whereby Option TLV may be filled with customized content, and a queue number and action (disable, i.e. the first operation identification) that need to be stopped are transmitted to a receiving end (i.e. the target switch). FIG. 7 is a schematic diagram of a first control instruction according to some embodiments of the present application. As shown in FIG. 7, an LLDP packet includes a 16-byte header. A 9-byte device chassis identity document (ID) TLV, such as a MAC (Media Access Control) address or name, has a type code of 1 and a length that is a total length of the TLV minus 4. A 5-byte port ID TLV, such as a port number or name of a device, has a type code of 2 and a length that is a total length of the TLV minus 4. A 4-byte time to live TLV provides time to live (which may be, but not limited to seconds, minutes, or the like) of a link layer discovery protocol data unit (LLDPDU) and has a type code of 3.

14-byte optional TLVs provide other information such as a device type and a management IP address. The optional TLVs include a 1-byte TLV type, a 1-byte TLV length, a 3-byte organization unique code, a 1-byte padding, and 8-byte epoch time. An organization unique code field may, but is not limited to, carry a queue number of a message to be discarded and an action (enable or disable, i.e. the first operation identification).

A 2-byte end of LLDPDU TLV has a type code of 0 and a length of 0. A 4-byte frame check sequence is used to verify integrity of a frame.

In some exemplary embodiments, a first control instruction may be transmitted to the target switch by, but not limited to, the following mode: transmitting the first control instruction to a fourth transmission module in the target switch by a network controller through a third transmission module in the reference switch, where the first control instruction includes an IP address of the reference switch, an IP address of the target switch, a first port number of a first port of the reference switch, a second port number of a second port of the target switch, a queue number of the target message queue, and a first operation identification; and the first operation identification is configured for performing the discarding operation on the message.

In these embodiments, the reference switch may, but not limited to, transmit the IP address of the reference switch, the first port number of the first port of the reference switch, and the queue number of the target message queue and the first operation identification to the network controller. The network controller obtains the IP address of the target switch corresponding to the IP address of the reference switch, obtains the second port number of the second port of the target switch corresponding to the first port number of the first port of the reference switch, then puts the IP address of the reference switch, the IP address of the target switch, the first port number of the first port of the reference switch, the second port number of the second port of the target switch, the queue number of the target message queue, and the first operation identification into the first control instruction, and transmits the first control instruction to the target switch.

In some exemplary embodiments, a second control instruction may be transmitted to the target switch by, but not limited to the following mode: obtaining a second transmission quantity that is recorded in the PFC counter in the reference switch and that corresponds to the target message queue; and in a case that the second transmission quantity satisfies a preset second control condition, transmitting the second control instruction to the target switch, where the second control instruction is configured for instructing a retaining operation on a message in the target message queue.

In these embodiments, after the first control instruction is transmitted to the target switch, the second transmission quantity that is recorded in the PFC counter in the reference switch and that corresponds to the target message queue may be further obtained, but is not limited thereto. In a case that the second transmission quantity satisfies the preset second control condition, it may indicate that the PFC storm in the target message queue on the target switch has disappeared. In this case, the second control instruction may be transmitted to the target switch, whereby the target switch may perform the retaining operation on the message in the target message queue.

In some exemplary embodiments, determining that the second transmission quantity satisfies the second control condition may include, but is not limited to, one of the following scenarios:

Scenario I: in a case that the second transmission quantity is less than a preset third quantity threshold, determining that the second transmission quantity satisfies the second control condition.

Scenario II: in a case of determining, based on the second transmission quantity, that a quantity of PFC pause frames that are transmitted by the reference switch to the target switch within second preset duration and that correspond to the target message queue is less than a preset fourth quantity threshold, determining that the second transmission quantity satisfies the second control condition.

In these embodiments, the first preset duration and the second preset duration may be same or different, but is not limited thereto.

In some exemplary embodiments, a second control instruction may be transmitted to the target switch by, but not limited to, the following mode: transmitting the second control instruction to the second transmission module in the target switch through the first transmission module in the reference switch, where the first transmission module and the second transmission module are connected through the first port of the reference switch and the second port of the target switch; the target message queue is the message queue at the second port on the target switch; the second control instruction includes the queue number of the target message queue and the second control identification; and the second operation identification is configured for performing the retaining operation on the message.

In these embodiments, in a case that the first transmission module of the reference switch and the second transmission module of the target switch are connected through the first port and the second port, it may indicate that the reference switch and the target switch are directly connected. In this case, the second control instruction may be transmitted to the second transmission module of the target switch through the first transmission module.

In some exemplary embodiments, a second control instruction may be transmitted to the target switch by, but not limited to, the following mode: transmitting the second control instruction to the second LLDP module in the target switch via the target transmission link through the first LLDP module in the reference switch, where the second control instruction is a message that is encapsulated in the transmission format of LLDP; and the target transmission link is the transmission link between the first port and the second port.

In these embodiments, different transmission links are provided between different ports of the target switch and different ports of the reference switch.

In some exemplary embodiments, a second control instruction may be transmitted to the target switch by, but not limited to, the following mode:
transmitting the second control instruction to the fourth transmission module in the target switch by the network controller through the third transmission module in the reference switch, where the second control instruction includes the IP address of the reference switch, the IP address of the target switch, the first port number of the first port of the reference switch, the second port number of the second port of the target switch, the queue number of the target message queue, and the second operation identification; and the second operation identification is configured for performing the retaining operation on the message.

In these embodiments, the reference switch may, but not limited to, transmit the IP address of the reference switch, the first port number of the first port of the reference switch, the queue number of the target message queue, and the second operation identification to the network controller. The network controller obtains the IP address of the target switch corresponding to the IP address of the reference switch, obtains the second port number of the second port of the target switch corresponding to the first port number of the first port of the reference switch, then puts the IP address of the reference switch, the IP address of the target switch, the first port number of the first port of the reference switch, the second port number of the second port of the target switch, the queue number of the target message queue, and the second operation identification into the first control instruction, and transmits the first control instruction to the target switch.

In some exemplary embodiments, the retaining operation may be performed on the message in the target message queue at the second port of the target switch by, but not limited to, the following mode: deleting an access control list (ACL) rule generated by an ACL control module, where the ACL rule is configured for instructing the discarding operation on the message in the target message queue.

In these embodiments, in a case that the PFC storm has disappeared, the target switch may delete the ACL rule to recover a PFC behavior, thereby performing the retaining operation on the message in the target message queue.

In some exemplary embodiments, a retaining operation may be performed on the message in the target message queue at the second port of the target switch by, but not limited to, the following mode: obtaining the second port number, the queue number of the target message queue, and the second operation identification from the second control instruction; and performing the retaining operation on the message in the target message queue at the second port of the target switch, where the second port is a port identified by the second port number; the target message queue is a message queue identified by the queue number; and the retaining operation is an operation indicated by the second operation identification.

In these embodiments, the target switch may, but is not limited to, have a plurality of ports. In a case of obtaining the second control instruction transmitted by the reference switch, the second port number, the queue number of the target message queue, and the second operation identification may be obtained from, but not limited to, the second control instruction. The second port identified by the second port number is obtained from the plurality of ports, and the target message queue identified by the queue number is obtained from a plurality of queues in the second port. The retaining operation is performed on the message in the target message queue.

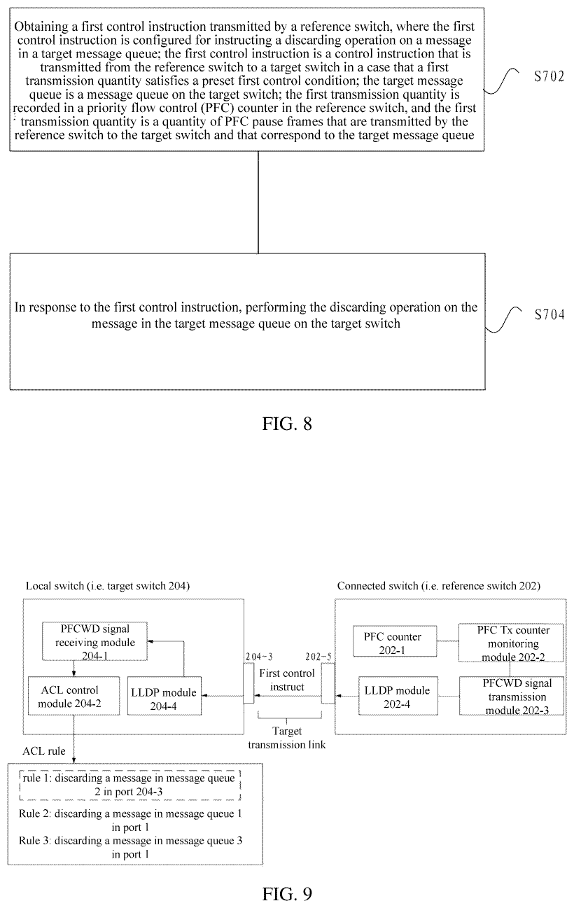

These embodiments provide a switch control method run on the above mobile terminal. FIG. 8 is a flowchart II of a switch control method according to some embodiments of the present application. As shown in FIG. 8, the flow includes the following steps:
Step S702, obtaining a first control instruction transmitted by a reference switch, where the first control instruction is configured for instructing a discarding operation on a message in a target message queue; the first control instruction is a control instruction that is transmitted from the reference switch to a target switch in a case that a first transmission quantity satisfies a preset first control condition; the target message queue is a message queue on the target switch; and the first transmission quantity is recorded in a priority flow control (PFC) counter in the reference switch, and the first transmission quantity is a quantity of PFC pause frames that are transmitted by the reference switch to the target switch and that correspond to the target message queue.
Step S704, in response to the first control instruction, performing the discarding operation on the message in the target message queue on the target switch.

By the above steps, in the process of transmitting a message by the target switch to the reference switch, the PFC counter in the reference switch records the quantity of PFC pause frames that are transmitted by the reference switch to the target switch and that correspond to the target message queue. In a case that the quantity of pause frames satisfies a control condition, it may indicate that a PFC storm occurs in the target message queue on the target switch. In this case, a control instruction is transmitted to a switch without a PFC counter function, to cause the switch without the PFC counter function to discard a message in a congested message queue in a timely manner, thereby avoiding aggravation of the congestion of the message queue, in which the PFC storm occurs, on the target switch. Therefore, the problem that the switch without the PFC counter may not detect a PFC storm may be solved, whereby the switch without the PFC counter may detect a PFC storm in a timely manner in a case that the PFC storm occurs.

An execution entity of the above steps may be, but is not limited to, a terminal and the like.

Execution orders of step S702 and step S704 may be interchanged. That is, step S704 may be executed before step S702.

In the technical solution provided in step S702, in a case that the reference switch determines, based on the first transmission quantity, that the PFC storm occurs in the target message queue on the target switch, the reference switch may, but is not limited to, transmit the first control instruction to the target switch.

In the technical solution provided in step S704, in a case of obtaining the first control instruction, the target switch may, but is not limited to, discard the message in the target message queue in response to the first control instruction, thereby avoiding collapse and paralysis of an entire link and improving stability between transmission links of switches.

In some exemplary embodiments, a first control instruction transmitted by a reference switch may be obtained by, but not limited to, the following mode: obtaining the first control instruction transmitted by a first port of the reference switch to a second port of the target switch, where the first control instruction includes a queue number of the target message queue and a first operation identification; the first operation identification is configured for performing the discarding operation on the message; the target message queue is a message queue at the second port of the target switch.

In some exemplary embodiments, the discarding operation may be performed on the message in the target message queue on the target switch by, but not limited to, the following mode: obtaining the queue number of the target message queue and the first operation identification from the first control instruction; and performing the discarding operation on the message in the target message queue at the second port of the target switch, where the target message queue is a message queue identified by the queue number; and the discarding operation is an operation indicated by the first operation identification.

In some exemplary embodiments, the discarding operation may be performed on the message in the target message queue on the target switch by, but not limited to, the following mode: generating an access control list (ACL) rule through an ACL control module in the target switch, where the ACL rule is configured for instructing the discarding operation on the message in the target message queue; and performing the discarding operation on the message in the target message queue based on the ACL rule.

In these embodiments, the message in the target message queue may be discarded by, but not limited to, generating the ACL rule in the target switch. FIG. 9 is a schematic diagram I of performing a discarding operation on a message in a target message queue according to some embodiments of the present application. As shown in FIG. 9, a connected switch (i.e. a reference switch 202) and a local switch (i.e. a target switch 204) are connected through a port 202-5 (i.e. a first port) and a port 204-3 (i.e. a second port). A PFC Tx counter monitoring module 202-2 in the connected switch is configured for: monitoring a PFC counter 202-1 in a PFC transmission direction on a queue in a port of the connected switch in real time, and recording duration. In a case that the connected switch determines that a PFC storm occurs in a target message queue on the local switch, a first control instruct may be transmitted by, but not limited to, a PFCWD signal transmission module through an LLDP module 202-4 (i.e. the above first LLDP module) and a target transmission link between the port 202-5 and the port 204-3.

In a case that an LLDP module 204-4 (i.e. the above second LLDP module) in the local switch obtains the first control instruct, a PFCWD signal receiving module may, but is not limited to, parse a first operation identification and a queue number of the target message queue in the first control instruct. In this case, an ACL control module 204-2 (i.e. the above ACL control module) may be triggered, but is not limited thereto. By adding rule 1: discarding a message in message queue 2 in the port 204-3, the discarding operation may be performed on the message in message queue 2 in the port 204-3.

It should be noted that the ACL control module 204-2 may further have another ACL rule, such as rule 2: discarding a message in message queue 1 in port 1 and rule 3: discarding a message in message queue 3 in port 1.

In some exemplary embodiments, the discarding operation may be performed on the message in the target message queue at the second port of the target switch by, but not limited to, the following mode: generating an ACL rule through an ACL control module in the target switch, where the ACL rule is configured for instructing the discarding operation on the message in the target message queue at the second port; and performing the discarding operation on the message in the target message queue at the second port based on the ACL rule.

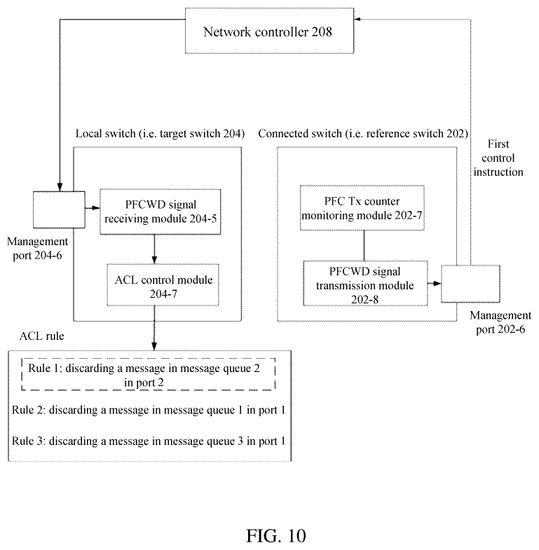

In these embodiments, the message in the target message queue may be discarded by, but not limited to, generating the ACL rule in the target switch. FIG. 10 is a schematic diagram II of performing a discarding operation on a message in a target message queue according to some embodiments of the present application. As shown in FIG. 10, a PFC Tx counter monitoring module 202-7 of a connected switch (i.e. a reference switch 202) is configured for: monitoring a PFC counter 202-1 in a PFC transmission direction on a queue in a port of the connected switch in real time, and recording duration.

In a case that the connected switch (i.e. the reference switch 202) determines that a PFC storm occurs in a target message queue in a second port of the local switch (i.e. the target switch 204), an IP address of the reference switch, a first port number of a first port of the reference switch, a queue number of the target message queue, and a first operation identification may be transmitted to a network controller 208 through, but not limited to, a PFCWD signal transmission module 202-8 via a management port 202-6. The network controller 208 obtains an IP address of the target switch corresponding to the IP address of the reference switch and a second port number of a second port of the target switch corresponding to the first port number of the first port, and puts the IP address of the reference switch, the IP address of the target switch, the first port number of the first port of the reference switch, the second port number of the second port of the target switch, the queue number of the target message queue, and the first operation identification into the first control instruct.

The network controller 208 transmits the first control instruct to the local switch through a management port 204-6 of the local switch. In a case of receiving the first control instruct, a PFCWD signal receiving module 204-5 of the local switch parses the second port number of the second port, the queue number of the target message queue, and the first operation identification in the first control instruct, and triggers an ACL control module 204-7 to generate rule 1: discarding a message in message queue 2 (i.e. the above target message queue) in port 2 (i.e. the above second port).

It should be noted that the ACL control module 204-2 may generate another ACL rule, such as rule 2: discarding a message in message queue 1 in port 1 and rule 3: discarding a message in message queue 3 in port 1.

According to the descriptions in the foregoing implementations, a person skilled in the art may clearly learn that the method according to the foregoing embodiments may be implemented by relying on software and an essential commodity hardware platform or by using hardware, but the former is a better implementation in most cases. Based on such an understanding, the technical solutions of the embodiments of the present application essentially, or the part contributing to the prior art, may be presented in the form of a software product. The computer software product is stored in a storage medium (e.g. a read only memory/random-access memory (ROM/RAM), a magnetic disk, or a compact disc) including several instructions to enable a terminal device (which may be a mobile phone, a computer, a server, a network device, or the like) to perform the methods described in all the embodiments of present application.

These embodiments further provide a switch control apparatus. The apparatus is configured for implementing the above embodiments and implementations. Content that has been described will not be elaborated. As used below, the term “module” may be a combination of software and/or hardware that implements a predetermined function. Although the apparatus described in the following embodiments is implemented in software, the implementation of hardware or a combination of software and hardware is also possible and envisioned.

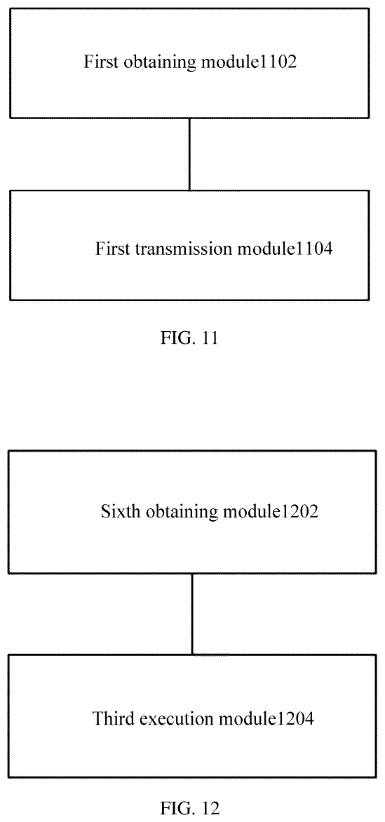

FIG. 11 is a structural block diagram I of a switch control apparatus according to some embodiments of the present application. As shown in FIG. 11, the apparatus includes:
a first obtaining module 1102, configured for obtaining a first transmission quantity that is recorded in a priority flow control (PFC) counter in a reference switch and that corresponds to a target message queue, where the first transmission quantity is a quantity of PFC pause frames that are transmitted by the reference switch to a target switch and that correspond to the target message queue, and the target message queue is a message queue on the target switch; and
a first transmission module 1104, configured for: in a case that the first transmission quantity satisfies a preset first control condition, transmitting a first control instruction to the target switch, where the first control instruction is configured for instructing a discarding operation on a message in the target message queue.

By the above apparatus, in the process of transmitting a message by the target switch to the reference switch, the PFC counter in the reference switch records the quantity of PFC pause frames that are transmitted by the reference switch to the target switch and that correspond to the target message queue. In a case that the quantity of pause frames satisfies a control condition, it may indicate that a PFC storm occurs in the target message queue on the target switch. In this case, a control instruction is transmitted to a switch without a PFC counter function, to cause the switch without the PFC counter function to discard a message in a congested message queue in a timely manner, thereby avoiding aggravation of the congestion of the message queue, in which the PFC storm occurs, on the target switch. Therefore, the problem that the switch without the PFC counter may not detect a PFC storm may be solved, whereby the switch without the PFC counter may detect a PFC storm in a timely manner in a case that the PFC storm occurs.

In some exemplary embodiments, the apparatus further includes:
a first determining module, configured for: before transmitting the first control instruction to the target switch, in a case that the first transmission quantity is greater than or equal to a preset first quantity threshold, determining that the first transmission quantity satisfies the first control condition; or
a second determining module, configured for: in a case of determining, based on the first transmission quantity, that a quantity of PFC pause frames that are transmitted by the reference switch to the target switch within first preset duration and that correspond to the target message queue is greater than or equal to a preset second quantity threshold, determining that the first transmission quantity satisfies the first control condition.

In some exemplary embodiments, the apparatus further includes:
a second obtaining module, configured for obtaining a previous transmission quantity, where the previous transmission quantity is a cumulative quantity of PFC pause frames that are transmitted by the reference switch to the target switch at a first moment and that correspond to the target message queue; the first transmission quantity is a cumulative quantity of PFC pause frames that are transmitted by the reference switch to the target switch at a second moment and that correspond to the target message queue; the first moment is earlier than the second moment; duration between the first moment and the second moment is the first preset duration; and
a third determining module, configured for determining a quantity difference between the first transmission quantity and the previous transmission quantity as the quantity of PFC pause frames that are transmitted by the reference switch to the target switch within the first preset duration and that correspond to the target message queue.

In some exemplary embodiments, the first transmission module includes:
a first transmission unit, configured for transmitting the first control instruction to a second transmission module in the target switch through a first transmission module in the reference switch, where the first transmission module and the second transmission module are connected through a first port of the reference switch and a second port of the target switch; the target message queue is a message queue at the second port of the target switch; the first control instruction includes a queue number of the target message queue and a first operation identification; and the first operation identification is configured for performing the discarding operation on the message.

In some exemplary embodiments, the first transmission unit is configured for:
transmitting the first control instruction to a second link layer discovery protocol (LLDP) module in the target switch via a target transmission link through a first LLDP module in the reference switch, where the first control instruction is a message that is encapsulated in a transmission format of LLDP; and the target transmission link is a transmission link between the first port and the second port.

In some exemplary embodiments, the first transmission module includes:
a second transmission unit, configured for transmitting the first control instruction to a fourth transmission module in the target switch by a network controller through a third transmission module in the reference switch, where the first control instruction includes an Internet protocol (IP) address of the reference switch, an IP address of the target switch, a first port number of a first port of the reference switch, a second port number of a second port of the target switch, a queue number of the target message queue, and a first operation identification; and the first operation identification is configured for performing the discarding operation on the message.

In some exemplary embodiments, the apparatus further includes:
a third obtaining module, configured for: after transmitting the first control instruction to the target switch, obtaining a second transmission quantity that is recorded in the PFC counter in the reference switch and that corresponds to the target message queue; and
a second transmission module, configured for: in a case that the second transmission quantity satisfies a preset second control condition, transmitting a second control instruction to the target switch, where the second control instruction is configured for instructing a retaining operation on a message in the target message queue.

In some exemplary embodiments, the apparatus further includes:
a fourth determining module, configured for: before transmitting the second control instruction to the target switch, in a case that the second transmission quantity is less than a preset third quantity threshold, determining that the second transmission quantity satisfies the second control condition; or
a fifth determining module, configured for: in a case of determining, based on the second transmission quantity, that a quantity of PFC pause frames that are transmitted by the reference switch to the target switch within second preset duration and that correspond to the target message queue is less than a preset fourth quantity threshold, determining that the second transmission quantity satisfies the second control condition.

In some exemplary embodiments, the second transmission module includes:
a third transmission unit, configured for transmitting the second control instruction to the second transmission module in the target switch through the first transmission module in the reference switch, where the first transmission module and the second transmission module are connected through the first port of the reference switch and the second port of the target switch; the target message queue is the message queue at the second port on the target switch; the second control instruction includes the queue number of the target message queue and the second operation identification; and the second operation identification is configured for performing the retaining operation on the message.

In some exemplary embodiments, the second transmission module includes:
a fourth transmission unit, configured for transmitting the first control instruction to a second link layer discovery protocol (LLDP) module in the target switch via a target transmission link through a first LLDP module in the reference switch, where the first control instruction is a message that is encapsulated in a transmission format of LLDP; and the target transmission link is a transmission link between the first port and the second port.

In some exemplary embodiments, the second transmission module includes:
a fifth transmission unit, configured for transmitting the second control instruction to the fourth transmission module in the target switch by the network controller through the third transmission module in the reference switch, where the second control instruction includes the IP address of the reference switch, the IP address of the target switch, the first port number of the first port of the reference switch, the second port number of the second port of the target switch, the queue number of the target message queue, and the second operation identification; and the second operation identification is configured for performing the retaining operation on the message.

In some exemplary embodiments, the apparatus further includes:
a fourth obtaining module, configured for: after transmitting the second control instruction to the target switch, obtaining the queue number of the target message queue and the second operation identification from the second control instruction, where the second control instruction is a control instruction received from the second port; and
a first execution module, configured for performing the retaining operation on the message in the target message queue at the second port of the target switch, where the target message queue is a message queue identified by the queue number; and the retaining operation is an operation indicated by the second operation identification.

In some exemplary embodiments, the first execution module includes:
a deletion unit, configured for deleting an access control list (ACL) rule generated by an ACL control module, where the ACL rule is configured for instructing the discarding operation on the message in the target message queue.

In some exemplary embodiments, the apparatus further includes:
a fifth obtaining module, configured for: after transmitting the second control instruction to the target switch, obtaining the second port number, the queue number of the target message queue, and the second operation identification from the second control instruction; and
a second execution module, configured for performing the retaining operation on the message in the target message queue at the second port of the target switch, where the second port is a port identified by the second port number; the target message queue is a message queue identified by the queue number; and the retaining operation is an operation indicated by the second operation identification.

FIG. 12 is a structural block diagram II of a switch control apparatus according to some embodiments of the present application. As shown in FIG. 12, the apparatus includes:
a sixth obtaining module 1202, configured for obtaining a first control instruction transmitted by a reference switch, where the first control instruction is configured for instructing a discarding operation on a message in a target message queue; the first control instruction is a control instruction that is transmitted from the reference switch to a target switch in a case that a first transmission quantity satisfies a preset first control condition; the target message queue is a message queue on the target switch; the first transmission quantity is recorded in a priority flow control (PFC) counter in the reference switch, and the first transmission quantity is a quantity of PFC pause frames that are transmitted by the reference switch to the target switch and that correspond to the target message queue; and
a third execution module 1204, configured for: in response to the first control instruction, performing the discarding operation on the message in the target message queue on the target switch.

By the above apparatus, in the process of transmitting a message by the target switch to the reference switch, the PFC counter in the reference switch records the quantity of PFC pause frames that are transmitted by the reference switch to the target switch and that correspond to the target message queue. In a case that the quantity of pause frames satisfies a control condition, it may indicate that a PFC storm occurs in the target message queue on the target switch. In this case, a control instruction is transmitted to a switch without a PFC counter function, to cause the switch without the PFC counter function to discard a message in a congested message queue in a timely manner, thereby avoiding aggravation of the congestion of the message queue, in which the PFC storm occurs, on the target switch. Therefore, the problem that the switch without the PFC counter may not detect a PFC storm may be solved, whereby the switch without the PFC counter may detect a PFC storm in a timely manner in a case that the PFC storm occurs.

In some exemplary embodiments, the sixth obtaining module is configured for obtaining the first control instruction transmitted by a first port of the reference switch to a second port of the target switch, where the first control instruction includes a queue number of the target message queue and a first operation identification; the first operation identification is configured for performing the discarding operation on the message; the target message queue is a message queue at the second port of the target switch; and
the third execution module is configured for: obtaining the queue number of the target message queue and the first operation identification from the first control instruction; and performing the discarding operation on the message in the target message queue at the second port of the target switch, where the target message queue is a message queue identified by the queue number; and the discarding operation is an operation indicated by the first operation identification.

In some exemplary embodiments, the third execution module includes:
a first generation unit, configured for generating an access control list (ACL) rule through an ACL control module in the target switch, where the ACL rule is configured for instructing the discarding operation on the message in the target message queue; and
a first execution module, configured for performing the discarding operation on the message in the target message queue based on the ACL rule.

In some exemplary embodiments, the sixth obtaining module is configured for transmitting the first control instruction to a fourth transmission module in the target switch by a network controller through a third transmission module in the reference switch, where the first control instruction includes an Internet protocol (IP) address of the reference switch, an IP address of the target switch, a first port number of a first port of the reference switch, a second port number of a second port of the target switch, a queue number of the target message queue, and a first operation identification; the first operation identification is configured for performing the discarding operation on the message; the target message queue is a message queue at the second port of the target switch;
the third execution module is configured for: obtaining the second port number, the queue number of the target message queue, and the first operation identification from the first control instruction; and performing the discarding operation on the message in the target message queue at the second port of the target switch, where the second port is a port identified by the second port number; and the target message queue is a message queue identified by the queue number; and the discarding operation is an operation indicated by the first operation identification.

In some exemplary embodiments, the third execution module includes:
a second generation unit, configured for generating an ACL rule through an ACL control module in the target switch, where the ACL rule is configured for instructing the discarding operation on the message in the target message queue at the second port; and
a first execution unit, configured for performing the discarding operation on the message in the target message queue at the second port based on the ACL rule.

It should be noted that the above modules may be implemented through software or hardware. For the latter, the various modules may be implemented in the following ways, but not limited to: The above modules are all located in the same processor; or, the aforementioned modules may be located in different processors in the form of any combination.

Some embodiments of the present application further provide a non-volatile readable storage medium, having a computer program stored thereon. The computer program is used to, when run, execute the steps in any one of the above method embodiments.

In some exemplary embodiments, the non-volatile readable storage medium may include but not limited to: various media that may store computer programs, such as a USB flash drive, a ROM, a RAM, a mobile hard disk drive, a magnetic disk, and a compact disc.

Some embodiments of the present application further provide an electronic apparatus, including a memory and a processor. The memory has a computer program stored thereon. The processor is configured for executing the computer program to perform the steps in any one of the above method embodiments.

In some exemplary embodiments, the electronic apparatus may further include a transmission device and an input/output device, where the transmission device is connected to the processor, and the input/output device is connected to the processor.

The examples in these embodiments may be found in the examples described in the above embodiments and exemplary implementations, and will not be elaborated in these embodiments.

Apparently, those skilled in the art should understand that the modules or the steps of the embodiments of the present application may be implemented using a universal computing apparatus, which may be concentrated on a single computing apparatus or distributed on a network composed of a plurality of computing apparatuses. The modules or steps may be implemented using program codes that may be executed by a computing apparatus, whereby the modules or steps may be stored in a storage apparatus for execution by the computing apparatus. Furthermore, in some cases, the steps shown or described may be executed in an order different from those here, or the steps may be separately made into various integrated circuit modules, or a plurality of modules or steps among the modules or steps may be made into single integrated circuit modules for implementation. In this way, the embodiments of the present application are not limited to any specific combinations of hardware and software.

The above descriptions are only embodiments of the present application, and are not intended to limit the embodiments of the present application. For those skilled in the art, the present application may have various modifications and changes. Any modification, equivalent replacement, and improvement made within the principles of the embodiments of the present application shall fall within the protection scope of the present application.

1. A switch control method, comprising:
obtaining a first transmission quantity that is recorded in a priority flow control (PFC) counter in a reference switch and that corresponds to a target message queue, wherein the first transmission quantity is a quantity of PFC pause frames that are transmitted by the reference switch to a target switch and that correspond to the target message queue, the target message queue is a message queue on the target switch, and the PFC counter is not disposed in the target switch; and
in a case that the first transmission quantity satisfies a preset first control condition, transmitting a first control instruction to the target switch, wherein the first control instruction is configured for instructing a discarding operation on a message in the target message queue;
wherein the transmitting a first control instruction to the target switch comprises:
transmitting the first control instruction to a second transmission module in the target switch through a first transmission module in the reference switch, wherein the first transmission module and the second transmission module are connected through a first port of the reference switch and a second port of the target switch; the target message queue is a message queue at the second port of the target switch; the first control instruction comprises a queue number of the target message queue and a first operation identification; and the first operation identification is configured for performing the discarding operation on the message; or
transmitting the first control instruction to a fourth transmission module in the target switch by a network controller through a third transmission module in the reference switch, wherein the first control instruction comprises an Internet protocol (IP) address of the reference switch, an IP address of the target switch, a first port number of a first port of the reference switch, a second port number of a second port of the target switch, a queue number of the target message queue, and a first operation identification; and the first operation identification is configured for performing the discarding operation on the message.

2. The method according to claim 1, wherein before the transmitting a first control instruction to the target switch, the method further comprises:
in a case that the first transmission quantity is greater than or equal to a preset first quantity threshold, determining that the first transmission quantity satisfies the preset first control condition; or
in a case of determining, based on the first transmission quantity, that a quantity of PFC pause frames that are transmitted by the reference switch to the target switch within a first preset duration and that correspond to the target message queue is greater than or equal to a preset second quantity threshold, determining that the first transmission quantity satisfies the preset first control condition.

3. The method according to claim 2, further comprising:
obtaining a previous transmission quantity, wherein the previous transmission quantity is a cumulative quantity of PFC pause frames that are transmitted by the reference switch to the target switch at a first moment and that correspond to the target message queue; the first transmission quantity is a cumulative quantity of PFC pause frames that are transmitted by the reference switch to the target switch at a second moment and that correspond to the target message queue; the first moment is earlier than the second moment; and a duration between the first moment and the second moment is the first preset duration; and
determining a quantity difference between the first transmission quantity and the previous transmission quantity as the quantity of PFC pause frames that are transmitted by the reference switch to the target switch within the first preset duration and that correspond to the target message queue.

4. (canceled)

5. The method according to claim 1, wherein the transmitting the first control instruction to the second transmission module in the target switch through the first transmission module in the reference switch comprises:
transmitting the first control instruction to a second link layer discovery protocol (LLDP) module in the target switch via a target transmission link through a first LLDP module in the reference switch, wherein the first control instruction is a message that is encapsulated in a transmission format of LLDP; and the target transmission link is a transmission link between the first port and the second port.

6. (canceled)

7. The method according to claim 2, wherein after the transmitting a first control instruction to the target switch, the method comprises:
obtaining a second transmission quantity that is recorded in the PFC counter in the reference switch and that corresponds to the target message queue; and
in a case that the second transmission quantity satisfies a preset second control condition, transmitting a second control instruction to the target switch, wherein the second control instruction is configured for instructing a retaining operation on a second message in the target message queue.

8. The method according to claim 7, wherein before the transmitting a second control instruction to the target switch, the method further comprises:
in a case that the second transmission quantity is less than a preset third quantity threshold, determining that the second transmission quantity satisfies the preset second control condition; or
in a case of determining, based on the second transmission quantity, that a quantity of PFC pause frames that are transmitted by the reference switch to the target switch within a second preset duration and that correspond to the target message queue is less than a preset fourth quantity threshold, determining that the second transmission quantity satisfies the preset second control condition.

9. The method according to claim 7, wherein the transmitting a second control instruction to the target switch comprises:
transmitting the second control instruction to the second transmission module in the target switch through the first transmission module in the reference switch, wherein the first transmission module and the second transmission module are connected through the first port of the reference switch and the second port of the target switch; the target message queue is a message queue at the second port of the target switch; the second control instruction comprises the queue number of the target message queue and a second operation identification; and the second operation identification is configured for performing the retaining operation on the second message.

10. The method according to claim 9, wherein the transmitting a second control instruction to the target switch comprises:
transmitting the second control instruction to a second link layer discovery protocol (LLDP) module in the target switch via a target transmission link through a first LLDP module in the reference switch, wherein the second control instruction is a message that is encapsulated in a transmission format of LLDP; and the target transmission link is a transmission link between the first port and the second port.

11. The method according to claim 7, wherein the transmitting a second control instruction to the target switch comprises:
transmitting the second control instruction to the fourth transmission module in the target switch by the network controller through the third transmission module in the reference switch, wherein the second control instruction comprises the IP address of the reference switch, the IP address of the target switch, the first port number of the first port of the reference switch, the second port number of the second port of the target switch, the queue number of the target message queue, and a second operation identification; and the second operation identification is configured for performing the retaining operation on the second message.

12. The method according to claim 7, wherein after the transmitting a second control instruction to the target switch, the method further comprises:
obtaining the queue number of the target message queue and a second operation identification from the second control instruction, wherein the second control instruction is received from the second port; and
performing the retaining operation on the second message in the target message queue at the second port of the target switch, wherein the target message queue is a message queue identified by the queue number; and the retaining operation is an operation indicated by the second operation identification.

13. The method according to claim 12, wherein the performing the retaining operation on the second message in the target message queue at the second port of the target switch comprises:
deleting an access control list (ACL) rule generated by an ACL control module, wherein the ACL rule is configured for instructing the discarding operation on the message in the target message queue.

14. The method according to claim 11, wherein after the transmitting a second control instruction to the target switch, the method further comprises:
obtaining the second port number, the queue number of the target message queue, and the second operation identification from the second control instruction; and
performing the retaining operation on the second message in the target message queue at the second port of the target switch, wherein the second port is a port identified by the second port number; the target message queue is a message queue identified by the queue number; and the retaining operation is an operation indicated by the second operation identification.

15. A switch control method, comprising:
obtaining a first control instruction transmitted by a reference switch, wherein the first control instruction is configured for instructing a discarding operation on a message in a target message queue; the first control instruction is a control instruction that is transmitted from the reference switch to a target switch in a case that a first transmission quantity satisfies a preset first control condition; the target message queue is a message queue on the target switch; the first transmission quantity is recorded in a priority flow control (PFC) counter in the reference switch, and the first transmission quantity is a quantity of PFC pause frames that are transmitted by the reference switch to the target switch and that correspond to the target message queue; the PFC counter is not disposed in the target switch; and
in response to the first control instruction, performing the discarding operation on the message in the target message queue on the target switch;
wherein the obtaining a first control instruction transmitted by a reference switch comprises:
obtaining the first control instruction transmitted by a first port of the reference switch to a second port of the target switch, wherein the first control instruction comprises a queue number of the target message queue and a first operation identification; the first operation identification is configured for performing the discarding operation on the message; the target message queue is a message queue at the second port of the target switch;
wherein the performing the discarding operation on the message in the target message queue on the target switch comprises:
obtaining the queue number of the target message queue and the first operation identification from the first control instruction; and performing the discarding operation on the message in the target message queue at the second port of the target switch, wherein the target message queue is a message queue identified by the queue number; and the discarding operation is an operation indicated by the first operation identification; or
wherein the obtaining a first control instruction transmitted by a reference switch comprises:
obtaining the first control instruction transmitted to a fourth transmission module in the target switch by a network controller through a third transmission module in the reference switch, wherein the first control instruction comprises an Internet protocol (IP) address of the reference switch, an IP address of the target switch, a first port number of a first port of the reference switch, a second port number of a second port of the target switch, a queue number of the target message queue, and a first operation identification; the first operation identification is configured for performing the discarding operation on the message; the target message queue is a message queue at the second port of the target switch;
wherein the performing the discarding operation on the message in the target message queue on the target switch comprises:
obtaining the second port number, the queue number of the target message queue, and the first operation identification from the first control instruction; and performing the discarding operation on the message in the target message queue at the second port of the target switch, wherein the second port is a port identified by the second port number; and the target message queue is a message queue identified by the queue number; and the discarding operation is an operation indicated by the first operation identification.

16. (canceled)

17. The method according to claim 15, wherein the performing the discarding operation on the message in the target message queue on the target switch comprises:
generating an access control list (ACL) rule through an ACL control module in the target switch, wherein the ACL rule is configured for instructing the discarding operation on the message in the target message queue; and
performing the discarding operation on the message in the target message queue based on the ACL rule.

18. (canceled)

19. The method according to claim 15, wherein the performing the discarding operation on the message in the target message queue at the second port of the target switch comprises:
generating an ACL rule through an ACL control module in the target switch, wherein the ACL rule is configured for instructing the discarding operation on the message in the target message queue at the second port; and
performing the discarding operation on the message in the target message queue at the second port based on the ACL rule.

20.-22. (canceled)

23. An electronic apparatus, comprising a memory, a processor, and a computer program stored on the memory and executable on the processor, wherein the processor, when executing the computer program:
implements steps of a switch control method, comprising:
obtaining a first transmission quantity that is recorded in a priority flow control (PFC) counter in a reference switch and that corresponds to a target message queue, wherein the first transmission quantity is a quantity of PFC pause frames that are transmitted by the reference switch to a target switch and that correspond to the target message queue, the target message queue is a message queue on the target switch, and the PFC counter is not disposed in the target switch; and
in a case that the first transmission quantity satisfies a preset first control condition, transmitting a first control instruction to the target switch, wherein the first control instruction is configured for instructing a discarding operation on a message in the target message queue;
wherein the transmitting a first control instruction to the target switch comprises:
transmitting the first control instruction to a second transmission module in the target switch through a first transmission module in the reference switch, wherein the first transmission module and the second transmission module are connected through a first port of the reference switch and a second port of the target switch; the target message queue is a message queue at the second port of the target switch; the first control instruction comprises a queue number of the target message queue and a first operation identification; and the first operation identification is configured for performing the discarding operation on the message; or
transmitting the first control instruction to a fourth transmission module in the target switch by a network controller through a third transmission module in the reference switch, wherein the first control instruction comprises an Internet protocol (IP) address of the reference switch, an IP address of the target switch, a first port number of a first port of the reference switch, a second port number of a second port of the target switch, a queue number of the target message queue, and a first operation identification; and the first operation identification is configured for performing the discarding operation on the message; or
implements steps of a switch control method, comprising:
obtaining a first control instruction transmitted by a reference switch, wherein the first control instruction is configured for instructing a discarding operation on a message in a target message queue; the first control instruction is a control instruction that is transmitted from the reference switch to a target switch in a case that a first transmission quantity satisfies a preset first control condition; the target message queue is a message queue on the target switch; the first transmission quantity is recorded in a priority flow control (PFC) counter in the reference switch, and the first transmission quantity is a quantity of PFC pause frames that are transmitted by the reference switch to the target switch and that correspond to the target message queue; the PFC counter is not disposed in the target switch; and
in response to the first control instruction, performing the discarding operation on the message in the target message queue on the target switch;
wherein the obtaining a first control instruction transmitted by a reference switch comprises:
obtaining the first control instruction transmitted by a first port of the reference switch to a second port of the target switch, wherein the first control instruction comprises a queue number of the target message queue and a first operation identification; the first operation identification is configured for performing the discarding operation on the message; the target message queue is a message queue at the second port of the target switch;
wherein the performing the discarding operation on the message in the target message queue on the target switch comprises:
obtaining the queue number of the target message queue and the first operation identification from the first control instruction; and performing the discarding operation on the message in the target message queue at the second port of the target switch, wherein the target message queue is a message queue identified by the queue number; and the discarding operation is an operation indicated by the first operation identification; or
wherein the obtaining a first control instruction transmitted by a reference switch comprises:
obtaining the first control instruction transmitted to a fourth transmission module in the target switch by a network controller through a third transmission module in the reference switch, wherein the first control instruction comprises an IP address of the reference switch, an IP address of the target switch, a first port number of a first port of the reference switch, a second port number of a second port of the target switch, a queue number of the target message queue, and a first operation identification; the first operation identification is configured for performing the discarding operation on the message; the target message queue is a message queue at the second port of the target switch;
wherein the performing the discarding operation on the message in the target message queue on the target switch comprises:
obtaining the second port number, the queue number of the target message queue, and the first operation identification from the first control instruction; and performing the discarding operation on the message in the target message queue at the second port of the target switch, wherein the second port is a port identified by the second port number; and the target message queue is a message queue identified by the queue number; and the discarding operation is an operation indicated by the first operation identification.

24. The method according to claim 2, further comprising:
determining the quantity of PFC pause frames that are transmitted by the reference switch to the target switch within the first preset duration and that correspond to the target message queue, according to quantities, recorded in the PFC counter in the reference switch, of PFC pause frames transmitted by the reference switch to a plurality of queues in a plurality of ports of the target switch.

25. The method according to claim 5, wherein after the transmitting the first control instruction to a second link layer discovery protocol (LLDP) module in the target switch via a target transmission link through a first LLDP module in the reference switch, the method comprises:
saving a link layer discovery protocol data unit (LLDPDU) received from the target switch in a form of a standard management information base (MIB).

26. The method according to claim 8, wherein the first preset duration and the second preset duration are same or different.

27. The method according to claim 8, wherein the reference switch and the target switch are directly connected.
